(19) United States
(12) Patent Application Publication
(10) Pub. No.: US 2015/0379751 A1
(43) Pub. Date: Dec. 31, 2015

(54) SYSTEM AND METHOD FOR EMBEDDING CODES IN MUTLIMEDIA CONTENT ELEMENTS

(71) Applicant: Cortica, Ltd., TEL AVIV (IL)

(72) Inventors: Igal Raichelgauz, New York, NY (US); Karina Odinaev, New York, NY (US); Yehoshua Y. Zeevi, Haifa (IL)

(73) Assignee: Cortica, Ltd., TEL AVIV (IL)

(21) Appl. No.: 14/836,254

(22) Filed: Aug. 26, 2015

Related U.S. Application Data
(63) Continuation-in-part of application No. 14/096,865, filed on Dec. 4, 2013.
Application No. 14/096,865 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/042,798, filed on Aug. 28, 2014.
(60) Provisional application No. 61/890,251, filed on Oct. 13, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06T 11/60

(52) U.S. Cl. CPC G06T 11/60; G06T 2201/005

(57) ABSTRACT

A method and system for embedding a code in a multimedia content item are provided. The method comprises identifying multimedia content elements existing in the multimedia content item; generating a new multimedia content element based on the identified existing multimedia content elements; and adding the at least one new multimedia content element to the multimedia content item.

### CROSS-REFERENCE TO RELATED APPLICATIONS

This application claims the benefit of U.S. Provisional Application No. 62/042,798 filed on Aug. 28, 2014. This application is also a continuation-in-part (CIP) of U.S. patent application Ser. No. 14/096,865 filed Dec. 4, 2013, now pending, which claims the benefit of U.S. provisional application No. 61/890,251 filed Oct. 13, 2013. The 14/096,865 Application is a continuation-in-part (CIP) of U.S. patent application Ser. No. 13/624,397 filed on Sep. 21, 2012, now allowed. The Ser. No. 13/624,397 application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221, filed May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference for all that they contain.

### TECHNICAL FIELD

The present invention relates generally to the analysis of multimedia content elements, and more specifically, to systems and methods for embedding codes in multimedia content elements.

### BACKGROUND

With the increasingly widespread use of mobile phones equipped with cameras, camera applications are becoming popular among mobile phone users. Mobile applications based on image matching (recognition) such as, for example, mobile visual searching, are currently emerging and gaining popularity.

Currently, there are a variety of mobile visual search applications for conducting a wide range of activities. For example, a user of a camera phone may point a camera phone at objects in the area surrounding the user in order to access relevant information associated with the objects. The information is provided responsive to a code (e.g., a quick response (QR) code) captured by the camera and processed by the phone.

Existing solutions for code-based information access cannot provide a user with information related to the image unless the user clearly captures a code in the image. Such solutions may not work properly when the code is not clearly visible from the user's position, or if there is no code associated with the surrounding objects. As a result, users may experience issues obtaining the information sought through such mobile visual search applications.

It would be therefore advantageous to provide a solution for seamlessly embedding codes in multimedia content elements.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method for embedding a code in a multimedia content item. The method comprises identifying multimedia content elements existing in the multimedia content item; generating a new multimedia content element based on the identified existing multimedia content elements; and adding the at least one new multimedia content element to the multimedia content item.

Certain embodiments disclosed herein also include a system for embedding a code in a multimedia content item. The system includes a processing unit; and a memory coupled to the processor, the memory contains instructions that when executed by the processor cause the system to: identify multimedia content elements existing in the multimedia content item; generate a new multimedia content element based on the identified existing multimedia content elements; and add the at least one new multimedia content element to the multimedia content item.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a network system utilized to describe the various embodiments disclosed herein.

FIG. 2 is a flowchart describing a method for embedding a code in multimedia content according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a flowchart illustrating a method for generating code-embedded multimedia content elements according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

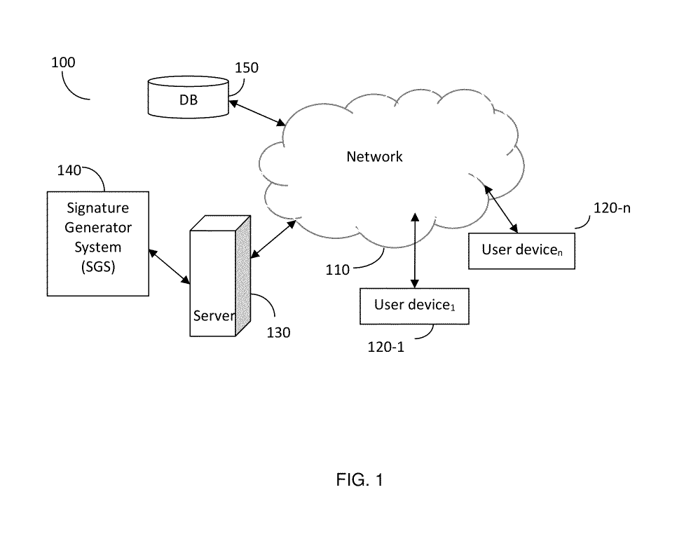

FIG. 1 shows an exemplary and non-limiting schematic diagram of a network system 100 utilized to describe the various embodiments disclosed herein. A network 110 is used to communicate between different parts of the network system 100. The network 110 may be the Internet, the world-wide-web (WWW), a local area network (LAN), a wide area network (WAN), a metro area network (MAN), and any other network capable of enabling communication between elements of the system 100.

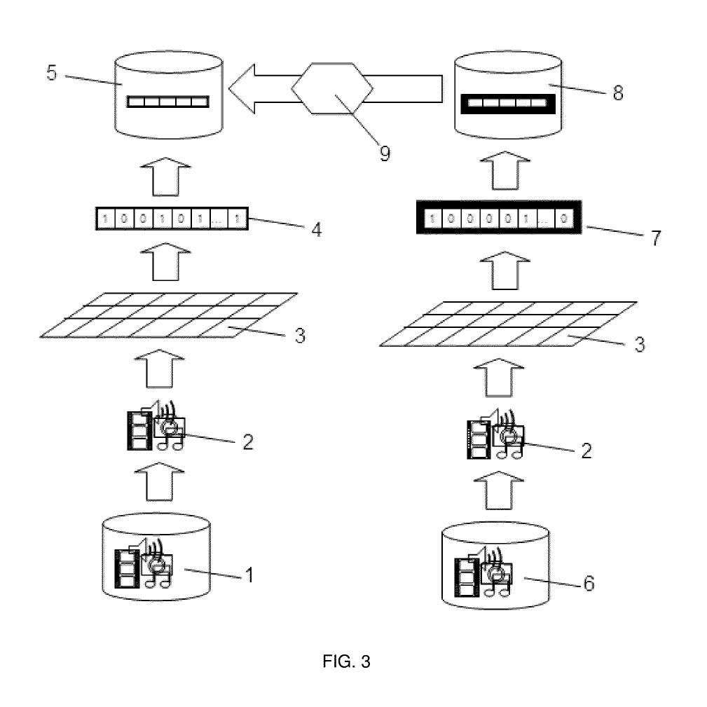

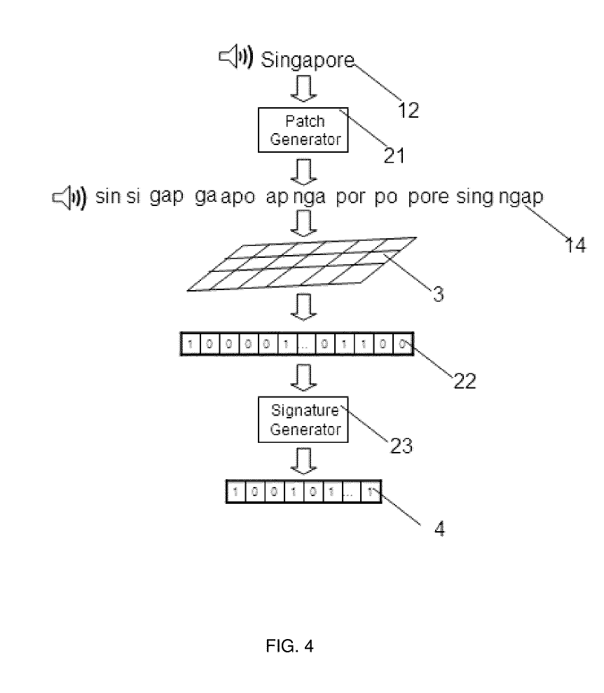

The server 130 is further connected to the network 110. Optionally, the system 100 also includes a signature generator system (SGS) 140. In one embodiment, the SGS 140 is connected either directly or through the network 110 to the server 130. In another embodiment, the SGS 140 is a component integrated in, or is added as an add-on to the server 130. The server 130 is configured to receive and serve multimedia content elements and to cause the SGS 140 to generate a signature respective of the multimedia content elements. The process for generating the signatures of multimedia content elements is explained in more detail herein below with respect to FIGS. 3 and 4.

According to the disclosed embodiments, the server 130 is configured to receive a request to add at least one code to a multimedia content item from a user device of the plurality of user devices 120 such as, for example, the user device 120-1. The code may be, but is not limited to, a quick response code (QR code), a digital watermark, a shot code, semacode, a data matrix code, and the like. The code includes a plurality of characters that may be numeric, alphabetical, graphical, or alphanumeric.

According to one embodiment, the request includes the multimedia content item. The multimedia content item may be, for example, an image, a graphic, a video stream, a video clip, an audio stream, an audio clip, a video frame, a photograph, an image of signals (e.g., spectrograms, phasograms, scalograms, etc.), and/or combinations thereof and portions thereof. The multimedia content item comprises a plurality of multimedia content elements. The server 130 is configured to identify each of the multimedia content elements in the multimedia content item. The identification may be made using the generation of signatures as further described herein below with respect of FIGS. 3 and 4. The server 130 is configured to determine at least one concept respective of each of the multimedia content elements based on the signatures.

A concept is a collection of signatures representing elements of the unstructured data and metadata describing the concept. The collection is a signature reduced cluster generated by inter-matching the signatures generated for the many objects, clustering the inter-matched signatures, and providing a reduced cluster set of such clusters. As a non-limiting example, a ‘Superman concept’ is a signature reduced cluster of signatures describing elements (such as multimedia content elements) related to, e.g., a Superman cartoon: a set of metadata representing textual representation of the Superman concept. Techniques for generating concepts and concept structures are also described in U.S. Pat. No. 8,266,185, assigned to a common assignee, which is hereby incorporated by reference for all that it contains.

It should be noted that each of the server 130 and the SGS 140 typically comprises a processing unit, such as a processor (not shown) or an array of processors coupled to a memory. In one embodiment, the processing unit may be realized through architecture of computational cores described in detail below. The memory contains instructions that can be executed by the processing unit. The instructions, when executed by the processing unit, cause the processing unit to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The server 130 also includes an interface (not shown) to the network 110.

An exemplary database of concepts is disclosed in U.S. Pat. No. 9,031,999, assigned to common assignee, which is hereby incorporated by reference for all the useful information it contains.

In another embodiment, the server 130 is configured to analyze the generated signatures to determine a context of the multimedia content item. A context is determined as the correlation between a plurality of concepts. An example for such indexing techniques using signatures is disclosed in the above-referenced ‘463 Application.

An exemplary technique for determining a context of a multimedia content item based on the generated signatures is described in detail in U.S. Pat. No. 9,087,049, assigned to a common assignee, which is hereby incorporated by reference for all the useful information it contains.

Respective of the identification of the multimedia content elements, the server 130 is configured to generate a multimedia content element that includes the at least one code therein. The generated multimedia content element is then added to the multimedia content item. According to another embodiment, the generated multimedia content element replaces at least one of the multimedia content elements of the multimedia content item. The server 130 may be configured to repair the multimedia content item that includes the newly generated multimedia content element. The repair enables seamless addition of the generated multimedia content element embedded with the code without damaging the multimedia content item. According to one embodiment, the repair is achieved by matching the original multimedia content item to the multimedia content item that includes the newly generated multimedia content element.

According to further embodiment, the system 100 may further include a database 150 configured to store data related to the code(s) as well as their associated multimedia content elements. According to another embodiment, the database 150 may further be used for the identification of the multimedia content elements.

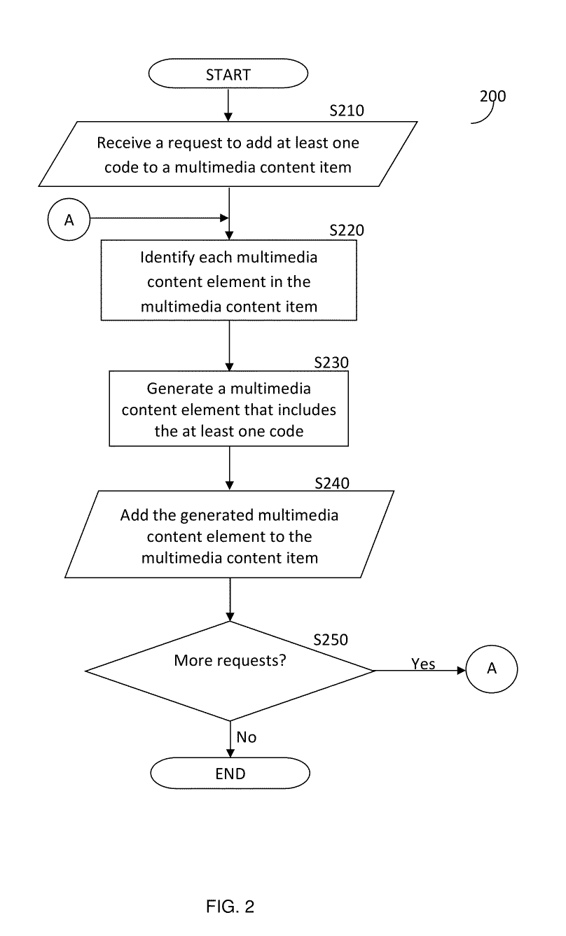

FIG. 2 is an exemplary and non-limiting flowchart 200 describing a method for adding a code to a multimedia content item according to an embodiment. In an embodiment, the method may be performed by a server (e.g., the server 130). In S210, a request to add at least one code to a multimedia content item that includes a plurality of multimedia content elements is received. The request may be received from a user device (e.g., the user device 120). The request may include the multimedia content item.

In S220, each of the multimedia content elements of the multimedia content item is identified. The identification may be made based on generation of signatures using an SGS (e.g., the SGS 140) as further described herein below with respect of FIGS. 3 and 4.

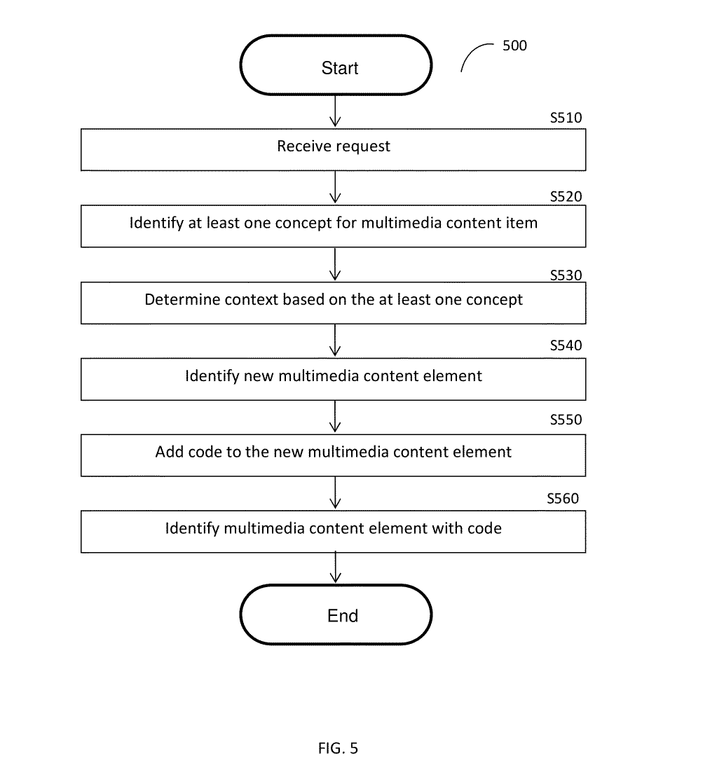

In S230, at least one new multimedia content element that includes the at least one code is generated based on the multimedia content item. Generation of new multimedia content elements is described further herein below with respect to FIG. 5.

In S240, the at least one generated multimedia content element is added to the multimedia content item. In an embodiment, the addition may be determined based on the location of other multimedia content elements within the multimedia content item. In a further embodiment, the addition may be any of: replacing at least one existing multimedia content element with the at least one generated multimedia content element, partially overlaying at least one existing multimedia content element with the at least one generated multimedia content element, and adding the at least one generated multimedia content element to the multimedia content item without overlaying any existing multimedia content element.

In S250, it is checked whether additional requests have been received and, if so, execution continues with S210; otherwise, execution terminates.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process will now be described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = ⊓ ( Vi - {Th}_{x} )$$

where, [symbol] is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thₓ is a constant Threshold value, where x is ‘S’ for Signature and ‘RS’ for Robust Signature; and Vi is a Coupling Node Value.

The Threshold values Thₓ are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ε)^{l}<<1

i.e., given that l nodes (cores) constitute a Robust Signature of a certain image I, the probability that not all of these l nodes will belong to the Signature of same, but noisy image, Ĩ is sufficiently low (according to a system's specified accuracy).

2: p(Vᵢ>TH_{RS})≈l/L

i.e., approximately I out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to common assignee, that are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications. Detailed description of the Computational Core generation and the process for configuring such cores is discussed in more detail in the above-referenced U.S. Pat. No. 8,655,801.

FIG. 5 is an exemplary and non-limiting flowchart 500 illustrating a method for generating a code-embedded multimedia content element according to an embodiment. In S510, a request to generate a code-embedded multimedia content element is received. The request contains the multimedia content item to which the generated multimedia content element will be added as well as the code to be embedded in the generated multimedia content element.

In S520, at least one concept of the received multimedia content item is identified. In an embodiment, a concept may be identified for each multimedia content element existing within the received multimedia content item. Concepts are described further herein above with respect to FIG. 1.

In S530, a context of the multimedia content item is determined respective of the at least one concept. A context is determined as the correlation between a plurality of concepts. An example for such indexing techniques using signatures is disclosed in the above-referenced '463 Application.

In S540, a new multimedia content element to be added to the received multimedia content item is identified. The identification may be based on the determined context. For example, if the context of a multimedia content item is determined to be “the beach,” the identified multimedia content element may be e.g., a beach ball, an umbrella, a crab, a sandcastle, and so on.

In S550, the code is added to the new multimedia content element. In an embodiment, the code may be added such that the code does not block interesting portions of the multimedia content element. In a non-limiting embodiment, such portions of the multimedia content element are interesting may be determined by, but not limited to, a patch attention processor (PAP).

A PAP is typically configured to create a plurality of patches from a multimedia content element. A patch of an image is defined by, for example, its size, scale, location, and orientation, and may be, but is not limited to, a portion (of a size of 20 pixels by 20 pixels) of an image of a size 1,000 pixels by 500 pixels. A patch of audio content may be a segment of audio 0.5 seconds in length from a 5 minute audio clip. Each patch is analyzed to determine its entropy, wherein the entropy is a measure of the amount of interesting information that may be present in the patch. For example, a continuous color of the patch has little interest while sharp edges, corners or borders, will result in higher entropy representing a lot of interesting information. The plurality of statistically independent cores, the operation of which is discussed in more detailed herein above, is used to determine the level-of-interest of the image and a process of voting takes place to determine whether the patch is of interest or not. If the entropy for a particular patch is below a particular threshold, the patch may be determined to not be interesting.

In S560, the multimedia content element having the code included therein is identified as the generated multimedia content element.

As a non-limiting example, a request to generate a code-embedded multimedia content element is received. The request includes a video multimedia content item featuring two cats interacting with a cat toy and a QR code to be added to the multimedia content item. A concept is identified respective of each cat and the cat toy. Based on the identified concepts, the context “cats playing” is determined. Respective of the determined context, a multimedia content element of a bowl of milk is identified. The QR code is included therein, and the QR code-embedded video is identified as the generated multimedia content element.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for embedding a code in a multimedia content item, comprising:
identifying multimedia content elements existing in the multimedia content item;
generating a new multimedia content element based on the identified existing multimedia content elements; and
adding the at least one new multimedia content element to the multimedia content item.

2. The method of claim 1, wherein generating the new multimedia content element further comprises:
providing the new multimedia content element based on the multimedia content item; and
adding the code to the new multimedia content element.

3. The method of claim 2, wherein identifying the new multimedia content element based on the multimedia content item further comprises:
identifying at least one concept for the multimedia content item; and
determining a context of the multimedia content item based on the at least one concept, wherein the new multimedia content item is provided based on the context.

4. The method of claim 3, wherein each of the at least one concept is identified based on one of the existing multimedia content elements.

5. The method of claim 2, wherein the added code is not overlaid over interesting at least a portion of the new multimedia content element.

6. The method of claim 1, further comprising:
repairing the multimedia content item with the new multimedia content element.

7. The method of claim 1, wherein adding the new multimedia content element to the multimedia content item further comprises:
replacing at least one of the existing multimedia content elements with the new multimedia content element.

8. The method of claim 1, wherein each of the at least one multimedia content item and at least one new multimedia content element is at least one of: an image, graphics, a video stream, a video clip, an audio stream, an audio clip, a video frame, a photograph, and images of signals.

9. The method of claim 1, wherein identifying multimedia content elements existing in the multimedia content item further comprises:
generating at least one signature respective of each existing multimedia content element.

10. A non-transitory computer readable medium having stored thereon instructions for causing one or more processing units to execute the method according to claim 1.

11. A system for embedding a code in a multimedia content item, comprising:
a processing unit; and
a memory coupled to the processor, the memory contains instructions that when executed by the processor cause the system to:
identify multimedia content elements existing in the multimedia content item;
generate a new multimedia content element based on the identified existing multimedia content elements; and
add the at least one new multimedia content element to the multimedia content item.

12. The system of claim 11, wherein the system is further configured to:
provide the new multimedia content element based on the multimedia content item; and
add the code to the new multimedia content element.

13. The system of claim 12, wherein the system is further configured to:
identify at least one concept for the multimedia content item; and
determine a context of the multimedia content item based on the at least one concept, wherein the new multimedia content item is provided based on the context.

14. The system of claim 13, wherein each of the at least one concept is identified based on one of the existing multimedia content elements.

15. The system of claim 12, wherein the added code is not overlaid over interesting at least a portion of the new multimedia content element.

16. The system of claim 11, wherein the system is further configured to:
repair the multimedia content item with the new multimedia content element.

17. The system of claim 11, wherein the system is further configured to:
replace at least one of the existing multimedia content elements with the new multimedia content element.

18. The system of claim 11, wherein the at least one multimedia content item is at least one of: an image, graphics, a video stream, a video clip, an audio stream, an audio clip, a video frame, a photograph, and images of signals.

19. The system of claim 1, wherein the system is further configured to:
generate at least one signature respective of each existing multimedia content element.
